(19) United States
(12) Patent Application Publication
(10) Pub. No.: US 2022/0305696 A1
(43) Pub. Date: Sep. 29, 2022

(54) UNCURED PREPREG RECYCLING METHODOLOGY

(71) Applicant: THE ROYAL INSTITUTION FOR THE ADVANCEMENT OF LEARNING / MCGILL UNIVERSITY, Montréal (CA)

(72) Inventors: Adam SMITH, Sainte-Genevieve (CA); Pasacal HUBERT, Roxboro (CA)

(21) Appl. No.: 17/616,795

(22) PCT Filed: Jun. 5, 2020
(86) PCT No.: PCT/CA2020/050781

§ 371 Date: Dec. 6, 2021

Related U.S. Application Data
(60) Provisional application No. 62/857,471, filed on Jun. 5, 2019.

(51) Int. Cl. B29B 17/02; B29C 70/54

(52) U.S. Cl. CPC B29B 17/0206; B29C 70/545; B29K 2105/0872

(57) ABSTRACT

The present disclosure provides methods and systems for manufacturing a composite component. User input indicative of component parameters for fabrication of the composite component are obtained, the component parameters including a prepreg offcut material parameter indicative of a prepreg offcut to be recycled. At least one staging parameter for a staging process of the prepreg offcut is determined based on the prepreg offcut material parameter. A compression moulding process map for the fabrication is determined based on the component parameters A manufacturing parameters for the fabrication is determined based on the compression moulding process map. At least one signal indicative of the staging parameters, the compression moulding process map, and the manufacturing parameters is issued.

### TECHNICAL FIELD

It is provided a process of recycling a prepreg material comprising a resin producing a moulding composition.

### BACKGROUND

Prepreg material correspond to a moulding material or structure comprising fibrous reinforcement material impregnated with a liquid resin matrix composition to the desired degree. Typically, the liquid resin matrix composition is substantially uncured or partially cured.

Prepreg material are typically lightweight and of high strength and are used in many structural applications such as in the automobile and aerospace industries and in industrial applications. Such applications typically require the prepreg material to comply with stringent requirements, often stipulated by the manufacturer of products for such applications, such as for example processing and storage of the materials especially where there is a need for safety considerations.

Prepregs may be produced by a range of methods which typically involve impregnation of a moving fibrous web with a liquid, molten or semi-solid uncured thermosetting resin matrix composition. The thermosetting resin matrix may be cast on a substrate before it is applied to the reinforcement material or alternatively, the thermosetting resin matrix composition may be applied directly to the fibrous reinforcement material (direct impregnation). Prepregs may also be manufactured by exposing the fibrous reinforcement to a solvated thermosetting resin matrix composition which is then followed by flashing off of the solvent.

Due to stringent compliance criteria requirements relating to handling, processing and storage of resins matrices and prepregs, recycling and subsequently re-use such products has been problematic. Furthermore, re-use of waste resin products has not proved economically viable to date.

There is thus still a need to be provided with new processes for recycling prepreg materials.

### SUMMARY

One aspect of the present disclosure is to provide a process of recycling a prepreg material comprising a resin producing a moulding composition comprising recovering prepreg offcuts, flow-compaction testing of the offcuts to determine staging parameters in view desired cure temperature (T_{cure}) and cycle time (t_{cycle}), staging the offcuts, determining the staged offcuts glass transition temperature (T_{g}^{post}) and comparing the glass transition temperature to the expected glass transition temperature (T_{g}^{target}) and accounting differences with a modification to the cure temperature and cycle time, stranding or cutting the staged offcuts into strands, and compression moulding the strands producing the recyclate or moulding composition.

In an embodiment, the process comprises the step of characterizing the resin from the offcuts.

In an embodiment, the resin is extracted with a razor blade before being characterized.

In a further embodiment, the target viscosity (ηₛₕₑₐᵣ) and flow window (t_{flow}) are further determined during the flow-compaction testing.

In another embodiment, the process comprises selecting cycle time(s) (t_{cycle,max}) and tooling temperature(s) (T_{tooling}) after the flow-compaction testing.

In a further embodiment, the process further comprises removing a protective backing film from the prepreg offcuts before the recycling process.

In an embodiment, the protective backing film is removed manually or through automation.

In another embodiment, the flow-compaction testing is accomplished on coupons collected from the offcuts.

In another embodiment, the coupons are subjected to a dynamic temperature scan to determine a glass transition temperature as received (T_{g0}).

In an additional embodiment, the process further comprises generating a process map allowing choosing the staging parameters (t_{stage}, T_{stage}, T_{g}^{target}) in terms of desired cure temperature (T_{cure}), cycle time (t_{cycle}), and resin viscosity.

In another embodiment, the strands are stored in sealed bags at −18° C. or at room temperature before being moulded.

In accordance with at least one aspect, there is provided a method for manufacturing a composite component. User input indicative of component parameters for fabrication of the composite component are obtained, the component parameters including a prepreg offcut material parameter indicative of a prepreg offcut to be recycled. At least one staging parameter for a staging process of the prepreg offcut is determined based on the prepreg offcut material parameter. A compression moulding process map for the fabrication is determined based on the component parameters. A manufacturing parameters for the fabrication is determined based on the compression moulding process map. At least one signal indicative of the staging parameters, the compression moulding process map, and the manufacturing parameters is issued.

In at least some embodiments, the component parameters include at least one of a complexity level for the composite component, a desired cure temperature for the composite component, a desired cure time for the composite component, and a glass transition temperature for the composite component.

In at least some embodiments, the staging parameters include at least one of a staging time, a staging temperature, and an staging glass transition temperature.

In at least some embodiments, the compression moulding process map defines at least one of a cycle time, a cure temperature, and a staging glass transition temperature.

In at least some embodiments, the manufacturing parameters include at least one of a final glass transition temperature, a cure temperature, a manufacturing cure time, and a moulding viscosity.

In at least some embodiments, inspecting the prepreg offcut, wherein the component parameters include at least one parameter determined based on the inspecting.

In at least some embodiments, the method comprises performing at least one preprocessing step on the prepreg offcut, the at least one preprocessing step comprising at least one of removal of a backing film from the prepreg offcut and cutting the prepreg offcut into a plurality of strands.

In at least some embodiments, the method comprises fabricating the composite component based on the at least one issued signal.

In at least some embodiments, issuing the at least one signal comprises issuing at least one command to an automated prepreg offcut recycling device.

In at least some embodiments, issuing the at least one signal comprises causing at least one of the staging parameters, the compression moulding process map, and the manufacturing parameters to be displayed to an operator via at least one display device.

In accordance with at least one other aspect, there is provided a system for manufacturing a composite component. The system comprises a processor and a non-transitory computer-readable medium having stored thereon program instructions. The program instructions are executable by the process for: obtaining user input indicative of component parameters for fabrication of the composite component, the component parameters including a prepreg offcut material parameter indicative of a prepreg offcut to be recycled; determining at least one staging parameter for a staging process of the prepreg offcut based on the prepreg offcut material parameter; determining a compression moulding process map for the fabrication based on the component parameters; determining manufacturing parameters for the fabrication based on the compression moulding process map; and issuing at least one signal indicative of the staging parameters, the compression moulding process map, and the manufacturing parameters.

In at least some embodiments, the component parameters include at least one of a complexity level for the composite component, a desired cure temperature for the composite component, a desired cure time for the composite component, and a glass transition temperature for the composite component.

In at least some embodiments, the staging parameters include at least one of a staging time, a staging temperature, and an staging glass transition temperature.

In at least some embodiments, the compression moulding process map defines at least one of a cycle time, a cure temperature, and a staging glass transition temperature.

In at least some embodiments, the manufacturing parameters include at least one of a final glass transition temperature, a cure temperature, a manufacturing cure time, and a moulding viscosity.

In at least some embodiments, the program instructions are executable for inspecting the prepreg offcut, wherein the component parameters include at least one parameter determined based on the inspecting.

In at least some embodiments, the program instructions are executable for performing at least one preprocessing step on the prepreg offcut, the at least one preprocessing step comprising at least one of removal of a backing film from the prepreg offcut and cutting the prepreg offcut into a plurality of strands.

In at least some embodiments, the program instructions are executable for fabricating the composite component based on the at least one issued signal.

In at least some embodiments, issuing the at least one signal comprises issuing at least one command to an automated prepreg offcut recycling device.

In at least some embodiments, issuing the at least one signal comprises causing at least one of the staging parameters, the compression moulding process map, and the manufacturing parameters to be displayed to an operator via at least one display device.

### BRIEF DESCRIPTION OF THE DRAWINGS

Reference will now be made to the accompanying drawings.

FIG. 1 illustrates example photographs of PW (left) and 8HS (right) prepreg surfaces, showing the non-uniform resin surface distribution caused by the prepregging process.

FIG. 2 illustrates a razor blade being drawn across the hot prepreg surface (A) and some of the corresponding resin obtained cooling on a steel plate (B).

FIG. 3 illustrates example box plot comparing the heat of reactions (left) and glass transition temperatures (right) of prepreg and extracted resin. The plot shows the population mean (dashed-line), median (solid line), interquartile distance (box), 25% and 75% limits (whiskers), and outliers (x-points).

FIG. 4 illustrates example measured and predicted cure rate isotherms for extracted 5276-1 resin.

FIG. 5 illustrates example measured and predicted laminate temperatures during cure model validation.

FIG. 6 illustrates example through-thickness temperature profiles during heat-up.

FIG. 7 illustrates example through-thickness temperature profiles during dwell and cool-down.

FIG. 8 illustrates example measured and predicted dynamic viscosity curves for extracted 5276-1.

FIG. 9 illustrates example measured and predicted isothermal viscosity curves for extracted 5276-1 resin.

FIG. 10 illustrates an example viscosity model verification cycle for extracted 5276-1 resin.

FIG. 11 illustrates example measured (DSC) and predicted glass transition temperatures of 5276-1 at various degrees of cure.

FIG. 12 illustrates example idealized representation of a flow-compaction test cure cycle.

FIG. 13 illustrates an example micrograph of a specimen moulded at 100° C. and 4 kN.

FIG. 14 illustrates an example process map showing cure temperature versus resin viscosity and gel-time.

FIG. 15 illustrates an example process map showing the effect of degree-of-cure on viscosity of 5276-1.

FIG. 16 illustrates an example shear strain versus resin viscosity for all staging conditions tested.

FIG. 17 illustrates an example representative specimen micrographs for each staged condition tested.

FIG. 18 illustrates an example shear strain versus mould closure rate for specimens staged to α=0.38.

FIG. 19 illustrates an example flow tailoring method workflow in accordance to one embodiment.

FIG. 20 illustrates example production offcuts.

FIG. 21 illustrates an example offcut processing platform.

FIG. 22 illustrates an example method for generating a recycled materials characterization database.

FIG. 23 illustrates an example method for manufacturing a composite component.

FIG. 24 illustrates an example compression moulding process map.

FIG. 25 illustrates an example computing device for implementing one or more of the methods of FIGS. 19, 22, and 23.

### DETAILED DESCRIPTION

The present disclosure provides, inter alia, a process of recycling a prepreg material comprising a resin to produce a moulding composition.

In some embodiments, the present disclosure provides a process of recycling a prepreg material comprising a resin producing a moulding composition comprising recovering prepreg offcuts. In an embodiment, the process comprises the step of characterizing the resin from the offcuts. Alternatively, it is also considered that said characterization of the resin is not necessary if the models needed exist in the literature. It is also considered herein that the resin is obtained from the manufacturer in the form of film or as bulk resin for characterization. Afterwards, flow-compaction testing of the offcuts to determine staging parameters in view desired cure temperature (T_{cure}) and cycle time (t_{cycle}), staging the offcuts. The compaction testing provides the relationship between resin viscosity, mould closure rate, prepreg fibre architecture and the magnitude and nature of the prepreg flow. Staging parameters are determined from the models obtained through the resin characterization, from the compaction testing results, and from the T_{cure} and t_{cycle} It follows the steps of determining the staged offcuts glass transition temperature (T_{g}^{post}) and comparing the glass transition temperature to the expected glass transition temperature (T_{g}^{target}) and accounting differences with a modification to the cure temperature and cycle time standing the staged cuts into strands, and compression moulding the strands producing the recyclate or moulding composition as described herein.

Strands of staged prepreg constitute a recyclate or moulding composition. This recyclate can then be subsequently compression moulded to obtain a part/structure/component which is made from recycled prepreg.

For the purposes of the present disclosure, the thermochemical and rheological characterization of the standard aerospace resin system Cycom® 5276-1 is discussed. It should be noted, however, that the embodiments described in the present disclosure are applicable to other types of resins and moulding materials. Semi-empirical phenomenological models for cure, viscosity, and glass transition temperature are populated by weighted non-linear least-squares regression and validated through independent experimentation. Although the present disclosure describes a number of phenomenological models, it should be noted that in certain embodiments, one or more empirical models, including one or more fully-empirical models, can be used, as appropriate. An instrumented compression moulding apparatus and an electro-mechanical testing frame are used to study the one-dimensional flow-compaction behaviour of woven prepreg strands for example, but not limited to, under various moulding conditions. A prepreg staging technique is used to isolate the effect of resin viscosity. Finally, a comprehensive flow tailoring methodology are presented.

The present disclosure discusses primarily two types of prepreg manufacturing waste, namely plain weave (PW) and eight-harness satin (8HS) offcuts produced by ply cutters. Both materials are impregnated with Cytec's Cycom® 5276-1 toughened epoxy. The present disclosure considers that the as-received state of the offcuts may vary from batch to batch, and that the offcuts are all within their specified out-life. Select technical specifications for example prepreg system are shown in Table 1 for comparison.

TABLE 1
Technical specifications for recovered Cycom ^{®}
5276-1 prepreg offcuts.

| Material Specification | Source #1 | Source #2 |
|---|---|---|
| Fibre Type | Thornel T650-PAN | Thornel T650-PAN |
| Fibre Architecture | Plain-weave | 8-harness-satin |
| Tow Size | 3k | 3k |
| Areal Weight | N/A | 370 gsm |
| Resin Content | 36% wt | 42% wt |
| Cured Resin Density | 1.29 g/cc | 1.29 g/cc |
| Out-Life (22° C.) | N/A | 15 days |
| Shelf-Life (<−18° C.) | N/A | 6 months |

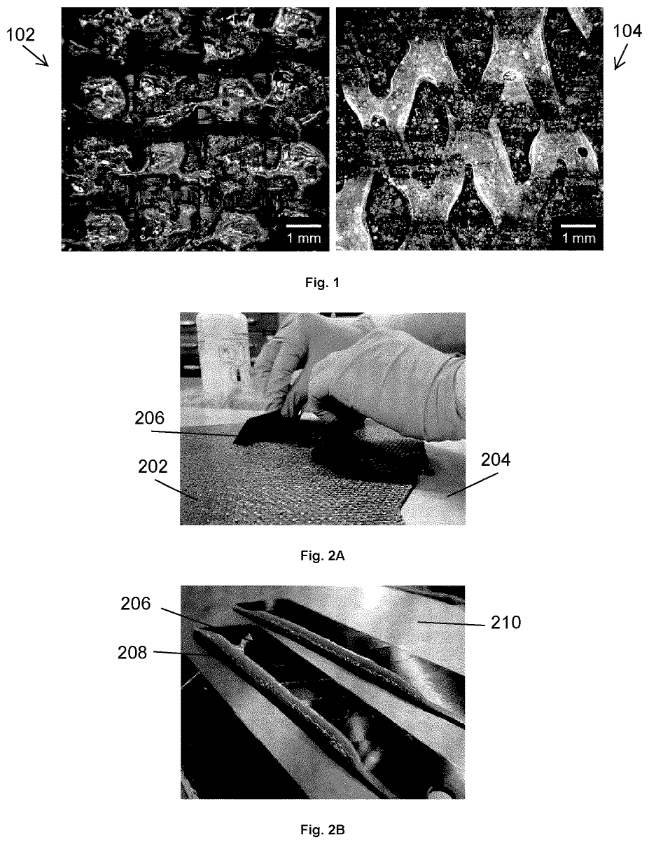

In general, polymer cure kinetic characterization by differential scanning calorimetry (DSC) using prepreg materials is discouraged, as they feature non-uniform resin morphologies which can result unpredictable variations in measured cure evolution magnitude. With reference to FIG. 1, images 102 and 104 taken of the offcuts from Source #1 and Source #2, respectively, illustrate these non-uniform resin morphologies.

Prepreg materials are also generally not suitable for performing parallel plate rheometry, as the presence of fibre affects the viscosity values obtained. For these reasons, characterization of the resin was performed using a resin extraction technique.

With reference to FIGS. 2A-B, the resin extraction procedure developed for the 5276-1 prepreg materials involves placing a single ply 202 of the 5276-1 prepreg material on an aluminium plate 204 preheated to a temperature between 60° C. and 70° C. A razor blade 206 is then drawn across the ply surface at 45° from the fibre direction with moderate pressure applied. After each pass, the recovered resin 208 is immediately placed on a cool metal surface 210 to avoid unwanted conversion. Each ply 202 is exposed to the heat of the aluminium plate 204 for a particular amount of time, for instance approximately 30 seconds.

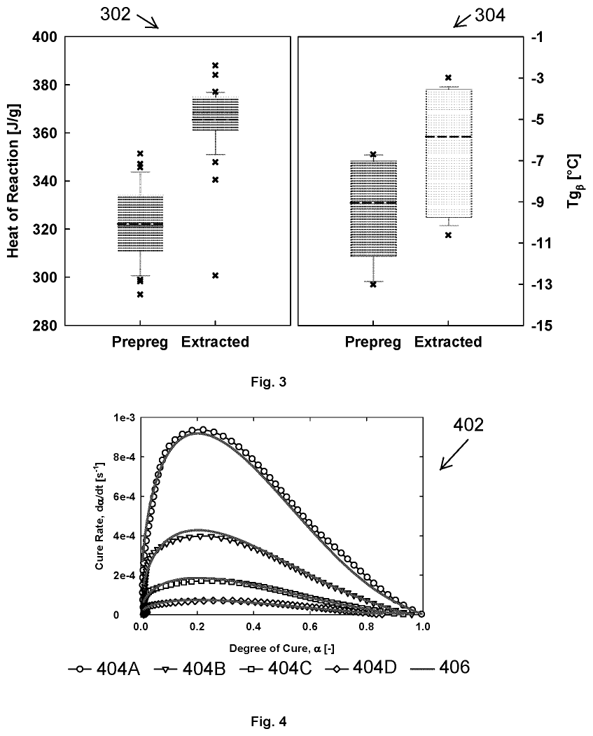

With additional reference to FIG. 3, modulated DSC testing was performed to compare the heat of reactions and β-stage glass transition temperatures of the original prepreg material and the extracted resin. An increase in degree-of-cure associated with the process was identified from the modulated DSC testing. As illustrated in charts 302 and 304, in one experiment, resin extraction resulted in an apparent increase in the average heat of reaction and T_{gB} of 43 J/g (13%) and 2.36° C. respectively. An increase in glass transition temperature is indicative of an amount of polymerisation having occurred due to the exposure to elevated temperature. However, the noted increase is smaller than the final Tg of 188° C. for the 5276-1 resin. The noted increase in heat of reaction, concurrent with the increase in degree-of-cure, can be interpreted as the resin content of the 8HS offcuts being lower than the rated 42%, or as the DSC sample not being representative of the average resin content. Additionally, a decrease of 42.3% in the interquartile range for measured values of heat of reaction also suggests that the assumption that heterogeneous resin distribution leads to DSC experimental scatter.

As part of the testing process, the curing behaviour of the extracted 5276-1 resin was studied using a combination of conventional and modulated DSC. Dynamic and isothermal scans were carried out on a Q100 DSC from TA Instruments to track the evolution of the resin cure rate under different time-temperature conditions. An example summary of the tests performed is shown below in Table 2.

TABLE 2
DSC test matrix for extracted 5276-1 resin.

| Test Type | Conditions | Repetitions |
|---|---|---|
| Dynamic Ramp | 2° C./min | 3-5 |
| Isothermal Dwell | 120, 140, 160, 180° C. | 3-5 |

To model the polymerization of the 5276-1 resin, a physics-based phenomenological cure model was selected. In one embodiment, the model is selected based on an isoconversional visualization method, described by Dykeman (“Minimizing uncertainty in cure modeling for composites manufacturing”, University of British Columbia, 2008, the entire contents of which are incorporated by reference herein). The phenomenological cure model indicates that a two-reaction autocatalytic model form with an additional diffusion factor is appropriate for the 5276-1 resin, described by equations (1) and (2) below:

$$\frac{d α}{d t} = {K}_{1} {{α}^{{m}_{1}} ( 1 - α )}^{{n}_{1}} + \frac{{K}_{2} {{α}^{{m}_{2}} ( 1 - α )}^{{n}_{2}}}{1 + exp ( D ( α - ( {α}_{C 0} + {α}_{C T} T ) ) )} \qquad ( 1 )$$

$$K = A exp ( - \frac{{E}_{a}}{R T} ) \qquad ( 2 )$$

where, in equation (1), α is the degree-of-cure of the material, K₁ and K₂ are Arrhenius coefficients, n₁, n₂, m₁, and m₂ are reaction orders, D is the diffusion coefficient of the material, α_{C0} is the critical degree-of-cure of the material at absolute zero, α_{CT} is the rate of increase of critical degree-of-cure of the material with temperature, and T is temperature in units of Kelvin. In equation (2), A is the pre-exponential factor, Eₐ is the activation energy of the material, R is the universal gas constant, and T is temperature in units of Kelvin.

The experimental cure rate curves, illustrated as curves 404A-D, and the corresponding model predictions, illustrated as curves 406, are presented in chart 402 of FIG. 4 for a variety of tested isothermal conditions. Derived model parameters are summarized in Table 3. The quality of the fit of the model to the experimental data was assessed using the adjusted coefficient of determination, which showed an agreement level at 180° C. of R²_{adj}=0.93. However, at lower temperatures, the fit quality decreased, including to R²_{adj}=0.78 at 120° C. As a result, a secondary validation of the cure model was performed.

TABLE 3
Summary of 5276-1 resin cure kinetic model parameters.

| Parameter | Reaction 1 | Reaction 2 |
|---|---|---|
| Aᵢ (s⁻¹) | 3.50 × 10⁴ | 2.50 × 10⁴ |
| E_{Ai} (J/mol) | 6.14 × 10⁴ | 7.20 × 10⁴ |
| mᵢ | 0.50 | 0.20 |
| nᵢ | 2.00 | 0.50 |
| D | — | 40 |
| α_{C0} | — | −7.03 × 10⁻¹ |
| α_{CT} (K⁻¹) | — | 3.73 × 10⁻³ |

Prediction of laminate temperatures can be performed based on thermocouple data obtained from outer surfaces of rubber brick. In some embodiments, a governing equation for one-dimensional (1D) unsteady heat conduction within an isotropic material through each component layer, presented at equation (3) below, is used:

$$\frac{\partial }{\partial t} ( ρ {C}_{P} T ) = \frac{\partial }{\partial x} ( k \frac{\partial T}{\partial x} ) + S \qquad ( 3 )$$

in which ρ is the density of the material, C_{P} is the specific heat capacity of the material, k is the thermal conductivity of the material, T is the temperature of the material, and S is a source term.

If an assumption of proportionality between resin cure rate and the rate of heat release is applied, the source term can be expressed as equation (4) below:

$$S = {H}_{T} \frac{\partial α}{\partial t} ( 1 - {V}_{f} ) {ρ}_{R} {C}_{P R} \qquad ( 4 )$$

where H_{T} is the total heat of reaction, V_{f} is the laminate fibre volume fraction for the material, ρ_{R} is the density of the resin, and C_{PR} is the specific heat capacity of the resin.

Solving the 1D heat transfer problem posed in equation (3) can be performed with the help of a composite processing simulation software, for instance the RAVEN™ software suite provided by Convergent Manufacturing Technologies. A summary of the thermo-physical properties of each material is included in Table 4.

TABLE 4
Thermo-physical properties of materials
used in validation simulations

| Property | Rubber | 5276-1 | T650-CF | Peel Ply | FEP |
|---|---|---|---|---|---|
| Density | 1540* | 1300* | 1770 | 1600 | 1720 |
| (kg/m³) | | | | | |
| Heat Capacity | 1019 + | 1525 + | 712 | 900 | 775 |
| (J/kg-K) | 1.97T^{‡} | 5.48T^{‡} | | | |
| Conductivity | 0.51^{‡} | 0.2^{‡} | 14/5 | 0.1 | 0.5 |
| (W/m-K) | | | | | |

*Supplier data sheet,
^{‡}Obtained experimentally

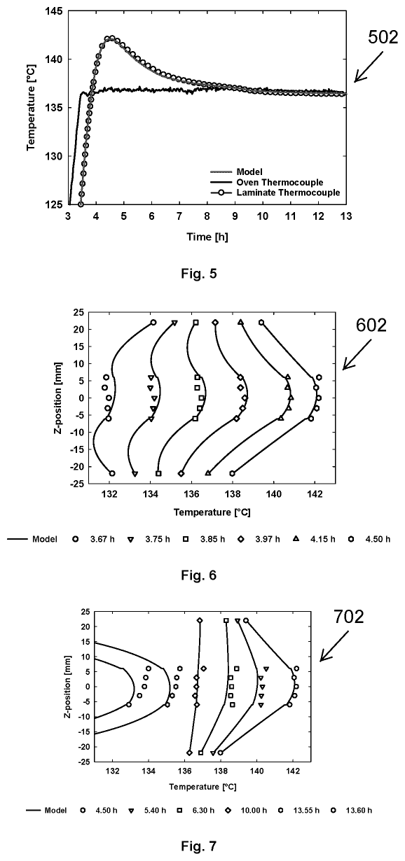

With reference to FIGS. 5, 6, and 7, the developed model demonstrated agreement to experimental results for temperature-over-time, illustrated in chart 502, as well as for through-thickness profile evolution, illustrated in charts 602 and 702. This additional information was used to validate the developed cure model.

To study the rheology of the 5276-1 resin, a parallel plate rheometry technique can be implemented, for example using an AR2000™ rheometer from TA Instruments. Additionally, dynamic and isothermal scans can be used to track the evolution of resin viscosity with respect to different time-temperature conditions. An example summary of tests which can be performed is shown in Table 5 below.

TABLE 5
Rheometry test matrix for extracted 5276-1 resin

| Test Type | Conditions | % Strain | Repetitions |
|---|---|---|---|
| Dynamic Ramp | 0.5, 1, 2° C./min | 1.0% | 1-4 |
| Isothermal Dwell | 80, 100, 120, | 1.0% | 2 |
| | 140, 160° C. | | |

Test data obtained from the tests detailed in Table 5 can be used to fit a viscosity model, for instance a modified version of the viscosity model proposed by Khoun et al. (Journal of Composite Materials, 2009, the entire contents of which are incorporated by reference herein). For instance, the viscosity model can be expressed as equations (5) and (6) below:

$$η = {η}_{1} + {{η}_{2} ( \frac{{α}_{gel}}{{α}_{gel} - α} )}^{A + BT α + CT {α}^{2}} \qquad ( 5 )$$

$${η}_{i} = {A}_{η i} exp ( - \frac{{E}_{η i}}{R T} ) , i = 1 , 2 \qquad ( 6 )$$

where, in equation (5), η is the dynamic resin viscosity, η₁ and η₂ are Arrhenius terms (given in equation (6)), α is the degree-of-cure, α_{gel} is the degree-of-cure at gelation, and A, B, and C are fitting parameters. In equation (6), A_{ηi} is the Arrhenius pre-exponential factor, E_{ηi} is the amount of energy required to overcome the polymer's internal resistance to strain, R is the ideal gas constant, and T is the temperature in units of Kelvin.

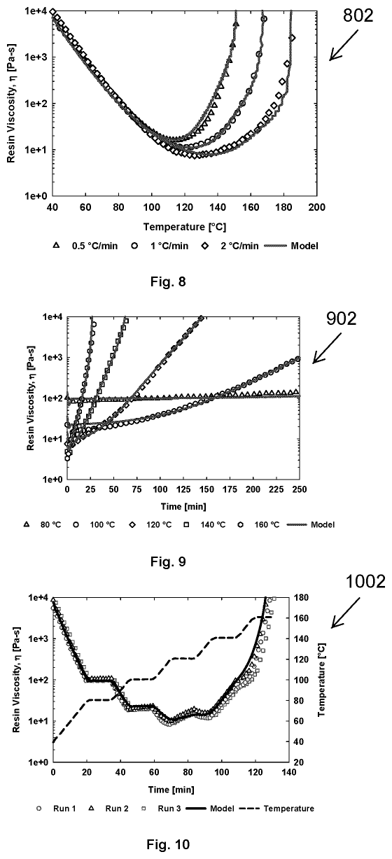

With reference to FIGS. 8 and 9, chart 802 illustrates the dynamic viscosity model fit to experimental data, and chart 902 illustrates the isothermal viscosity model fit to experimental data.

In some embodiments, the viscosity model of equations (5) and (6) can be augmented with an Arrhenius temperature-dependent term and a quadratic degree-of-cure term, for instance to help capture complex resin behaviour near gelation. Additionally, by performing a least-squares regression, a linear relationship between the model goodness-of-fit at different temperatures and the fitting parameters B and C of equation (5) can be determined. As a result, the viscosity model of equations (5) and (6) can be modified such that the fitting parameters B and C are made to vary linearly with temperature. In one example, the model parameters for the viscosity model of equations (5) and (6) are presented in the summary of model parameters in Table 6 below:

TABLE 6
Summary of 5276-1 viscosity model parameters

| Parameter | Term 1 | Term 2 (Gel Effects) |
|---|---|---|
| A_{ηi} | 1.00 × 10⁻¹³ | 9.37 × 10⁻³ |
| E_{ηi} | 1.01 × 10⁵ | 2.11 × 10⁴ |
| α_{gel} | — | 0.63 |
| A | — | 4.06 |
| B | — | −0.23T + 96.6 |
| C | — | 0.31T − 136.4 |

With reference to FIG. 10, to validate the ability of the viscosity model to predict non-idealized viscosity evolutions, a complex cure cycle consisting of both ramps and dwells can be used. Chart 1002 illustrates that the viscosity model for the 5276-1 material successfully predicts both temperature-dependent viscous and curing effects.

To assess the relationship between degree-of-cure and glass transition temperature for the 5276-1 material, modulated DSC testing can be performed. In one example, specimens of extracted neat resin, obtained via the technique described in relation to FIGS. 2A-B hereinabove, for both 8HS and PW prepreg materials were processed under a series of different time-temperature conditions to obtain incremental levels of cure from 0 to 1. A summary of the tests performed in this example is shown below in Table 7.

TABLE 7
DSC test matrix for glass transition temperature
characterization for 5276-1 resin

| Test Type | Form | Test Conditions | Outcome(s) |
|---|---|---|---|
| Dynamic Ramp | Neat | 2° C./min | T_{gβ}, T_{gult} |
| | 8HS | | |
| Isothermal Dwell | Neat | 80, 100, 120, | T_{gisomax}, T_{gult} |
| | | 140, 160° C. | |
| Sequential Ramps | PW | 150, 155, 160, | T_{gβ}, T_{gi}, T_{gult} |
| | | 175, 275° C. | |
| Interrupted | Neat | 5-60 min; Δt = 5 min | T_{gi}, T_{gult} |
| Isotherms | 8HS | 32, 87, 107, | |
| | | 122, 130.5 min | |

In one example, the DiBenedetto relationship, shown in equation (7) below, is chosen to represent the glass transition temperature versus degree-of-cure behaviour of the 5276-1 resin:

$$\frac{{T}_{g} - {T}_{g 0}}{{T}_{g ∞} - {T}_{g 0}} = \frac{λ α}{1 - ( 1 - λ ) α} \qquad ( 7 )$$

in which T_{g0}, T_{g∞}, and Tg are the initial (α=0), final (α=1), and intermediate (0<α<1) glass transition temperatures respectively, λ is a fitting parameter defined by Pascault and Williams (“Glass transition temperature versus conversion relationships for thermosetting polymers,” at 28: 85-95, 1990, the entire contents of which are incorporated by reference herein). In this example, the parameter λ is defined as a “ratio of segmental mobilities for a certain extent of reaction [α] with respect to the mixture of monomers [α=0]”, and varies between 0 and 1.

Continuing with the example of the Pascault and Williams-defined parameter λ, a fundamental approach can be used to show that the parameter λ is computed using the ratio of the initial and final glass transition temperatures, in cases in which the corresponding ratio of lattice energies is equal to unity. The parameter λ can thus be defined via equation (8) below:

$${λ}_{R a t i o} = \frac{{T}_{gi}}{{T}_{g ∞}} \qquad ( 8 )$$

The Pascault and Williams-defined parameter λ can be approximated using a gel point glass transition temperature, as shown in equation (9) below:

$${λ}_{Gel - Point} = \frac{2 {(}_{gel} {T}_{g} - {T}_{gi} )}{3 ( {T}_{g∞} - {}_{gel} {T}_{g} )} \qquad ( 9 )$$

where _{gel}T_{g} is the temperature at which gelation and vitrification occur simultaneously.

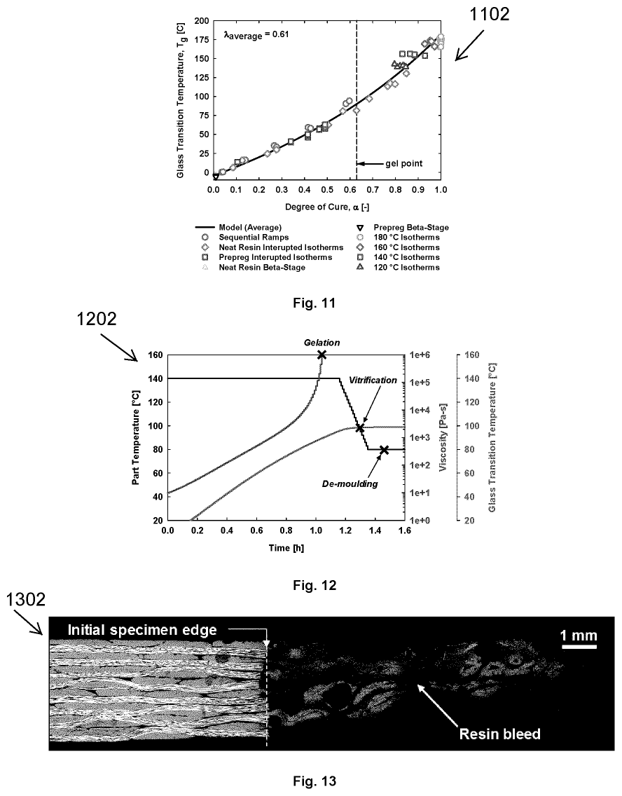

With reference to FIG. 11, additionally, in this example, λ is not determined based on theoretical considerations, and instead is used to obtain an improved fit vis-à-vis experimental data. The resulting model parameters for the present example are presented, with comparisons to the DSC data, in chart 1102 and in Table 8 below:

TABLE 8
Summary of 5276-1 DiBenedetto model parameters.

| Parameter | Value | R_{adj}² |
|---|---|---|
| T_{gi} | −4.61° C. | — |
| _{gel}T_{g} | 81.61° C. | — |
| T_{g∞} | 182° C. | — |
| λ-Best Fit | 0.66 | 0.991 |
| λ-Gel Point | 0.57 | 0.988 |
| λ-Ratio | 0.59 | 0.989 |

Different mechanisms contribute to the flow-compaction behaviour of fibre-reinforced polymers. A first is percolation flow, which is characterized by the movement of resin relative to a quasi-static fibre bed and is the dominant mechanism in certain processes, like Resin Transfer Moulding (RTM), Resin Film Infusion (RFI), autoclave curing, etc. Percolation flow is most frequently associated with thermosets and is modelled using Darcy's Law, a formulation of the conservation of momentum equation developed for soil mechanics. A second mechanism is shear flow, which features coupled movement of fibre and matrix and is dominant in certain processes, including compression moulding, injection moulding, thermoforming, etc. Due to the effective inextensibility of the fibre, shear flow manifests as interply and/or inraply shearing modes.

It has been shown that a strong relationship exists between material design, processing parameters, and final part quality. Deviation in material state prior to manufacturing, or in the processing parameters themselves, can lead to favouring of the wrong flow mechanisms, resulting in part defects.

The same principle applies to compressing moulding using prepreg strand. In cases in which the appropriate mechanisms are not excited, flow-related defects can manifest. In the case of woven strands, fibres restrict shear flow in both 0° and 90° directions, which can cause difficulties in successful feature filling and reducing resin bleed. However, because fabrics make up the vast majority of prepreg production waste, an understanding of the particular flow-compaction behaviour of fabrics may help with improved prepreg recycling techniques.

In at least one example, prepreg strands are stored in sealed bags at −18° C. until needed for testing, to preserve the state of the resin and avoid moisture contamination. In at least one other example, the prepreg strands are stored at room temperature in view of resin stabilisation techniques as described in WO 2017/109107, the entire content of which is incorporated herein by reference, although other approaches are also considered. Thus, the shelf life (time and temperature) can be predicted in view of resin stabilisation.

In some examples, shortly before a testing process is performed on the strands, the strands are thawed at room temperature until the still-sealed bag is free of condensation and no longer cool to the touch. The length (L₀) and width (W₀) of each strand is measured using a digital caliper and then stacked according a specified layup (e.g. [0₆]_{T}, [±45₃]_{T}, [0/90/±45]_{S}). The uncompressed specimen thickness (h₀) is also measured with a digital caliper and is used in a later step to calculate the material bulk factor. Finally, the specimen's initial mass (m₀) is measured using a precision scale.

In one particular example, a flow-compaction testing apparatus consisting of a 12.7 mm wide rectangular piston-channel mould made from AISI 4140 alloy steel can be used, although other moulds are also considered. In this example, a gap tolerance of 0.0127 mm between the piston and channel walls is provided to prevent resin or fibre from flowing in the z-direction during testing. The mould includes a removable flange to facilitate removal of cured specimens. Temperature is controlled using Firerod™ resistive cartridges heaters, an SD PID™ limit controller, and a K-Type™ thermocouple from Watlow. The cartridge heaters are fit in to copper plates using heat transfer paste to provide in-plane temperature uniformity across the mould surfaces. The testing apparatus in mounted on an Insight™ 5 kN table-top electromechanical testing frame from the MTS Corporation. Force is measured using the frame's 5 kN load cell and displacement of the upper and lower tooling surfaces is measured using an HS25 LVDT from Vishay Precision Group. Finally, blocks of machinable insulation prevent excessive heating of the load cell, as well as the surrounding work surfaces, for safe operation. A prepared specimen is placed inside the aforementioned piston-channel mould, which is preheated to the desired testing temperature. The piston head is initially lowered at 0.5 mm/s until a small preload of 25 N is applied to the specimen, at which point the crosshead position is held constant for one-minute to ensure that each test is performed under uniform isothermal conditions.

In this example, certain assumptions are made: (1) the gaps between adjacent strands has been completely removed, (2) no significant deformation of the fibre bed architecture has occurred, (3) no significant quantity of resin has bled from the specimen, and (4) the specimen constituents, fibre and liquid matrix, are effectively incompressible moving forward. The specimen volume is therefore given by:

V=L̅₀̅·W̅₀̅·h₀′ (10)

where L̅₀̅ is the average initial specimen length, W̅₀̅ is the average initial specimen width, and h̅₀̅′̅ is the specimen thickness following preloading.

Knowledge of the specimen volume, instantaneous specimen thickness (h(t)), and applied force (F(t)), along with the incompressibility assumption, makes it possible to calculate the specimen normal stress σ(t) at any point during the test:

$$σ ( t ) = \frac{F ( t ) \cdot h ( t )}{\overline{{L}_{0}} \cdot \overline{{W}_{0}} \cdot {h}_{0}^{′}} \qquad ( 11 )$$

With reference to FIG. 12, following temperature equilibration, the specimen is subjected to constant-displacement loading until the prescribed force is reached, at which point the frame switches to PID force-control for the remainder of the test. Using the models for viscosity and glass transition temperature described hereinabove, the length of the cure dwell and final cooling ramp can be selected to ensure gelation and verification of the specimen prior to demoulding, as illustrated in chart 1202. It should be noted that the curing approach described in this example, and illustrated in chart 1202, represents one example. Other approaches for curing, including hot-in hot-out type curing, are also considered.

After demoulding, any flashing is removed from the cured specimen and it is weighed to determine the amount of material lost due to flow in the z-direction (Δm). A particular test can be rejected when the mass loss surpasses 1% of the original specimen mass. Acceptable tests are evaluated to measure the final specimen thickness (h_{f}), for instance using a digital micrometer, and the material bulk factor is calculated according to Equation (12):

$$β = \frac{{h}_{0}}{{h}_{f}} \qquad ( 12 )$$

In this example, optical microscopy samples are prepared for optical micrographs of the specimen midplane, which can be carried out according to the recommendations outlined by Hayes and Gammon (“Optical Microscopy of Fiber-Reinforced Composites”, ASM international, 2010, the entire contents of which are incorporated by reference herein). Several specimens are cured in a potting resin under 80 psi (SI) to mitigate the presence of air bubbles. The resulting “puck” is sectioned to expose the specimens midplane using a precision saw or similar tool. These sections are then progressively ground and polished with various abrasive sizings, for instance of 220-1200 grit and 12.5-0.3 μm respectively. In this example, these operations are carried out on an automated polishing unit.

Once a satisfactory surface finish is obtained, specimens are imaged at magnification, for instance at 200×, using any suitable imaging device. In some cases, mosaic images can be created using an image stitching utility.

The final specimen length (L_{f}) is determined using a minimum fibre volume content limit approach, for instance of 20%. The selected limit can be based on the fibre volume contents typical of SMC (20-30%) and BMC (10-20%) compression moulded parts. Thus, specimen below 20% fibre volume content is considered resin bleed. In some test specimen, a dip below 20% is observed after the edge of the original prepreg stack, which, in some cases, coincided with the end of a large concentration of 0° fibres. In some cases, the fibre volume content increases beyond the 20% limit for the remainder of the specimen length. As a result, in this example, only the final dip below the 20% is used to determine the end-of-part.

The final shear strain is calculated using the Green tensor evaluated in the x-direction, which is shown in Equation (13). The Green strain tensor includes quadratic terms in addition to the small strain terms more commonly known as engineering strain. This makes the Green strain tensor rotation independent and preferred for large deformations.

$${e}_{x}^{S} = \frac{1}{2} [ {( 1 + \frac{{L}_{f} - \overline{{L}_{0}}}{\overline{{L}_{0}}} )}^{2} - 1 ] \qquad ( 13 )$$

Continuing with this example, the data captured by the testing frame and LVDT are processed using an algorithm to obtain the flow-compaction behaviour (σ vs. h/h₀) and the thickness evolution (h/h₀ vs. time). From these two relationships, the maximum normal stress (σₘₐₓ) and the flow window (t_{flow}) can be determined. The flow window, which is defined as the time required for 95% of the total specimen deformation to occur, can be expressed as:

t_{flow}=t|_{ΔhΔh}_{ₜₒₜₐₗ} (14)

The relationship between material state, processing parameters, and flow behaviour affects the ability to manufacture defect-free composite parts. Some effects of viscosity on resin systems designed for autoclave curing and for compression moulding are presented in Table 10. Since the manufacturer-recommend processing viscosities for autoclave and compression molding techniques differ by significant amounts, an important question remains regarding whether recovered autoclave prepreg offcuts can be made to behave like a material designed for compression moulding.

TABLE 10
Commercially available resins with
corresponding processing viscosities.

| Autoclave Curing | | Compression Moulding | |
|---|---|---|---|
| System | Viscosity | System | Viscosity |
| Hexcel 3501-6 | 0.4 Pa-s | TORELINA PPS | 150-400 Pa-s |
| Newport 321 | 1.5-3.5 | Vitrex HT- | 200 Pa-s |
| | Pa-s | G22 PEKK | |
| Hexcel 8552 | 1-10 Pa-s | Vitrex PEEK 151 | 300-700 |
| Newport 301 | 4.0-9.3 | | Pa-s [32] |
| | Pa-s | ULTEM PEI | 70-1500 Pa-s |
| Toray 3960 | 9-10 Pa-s | | |
| ACG | 5-50 Pa-s | | |
| MTM45-1 | | | |
| Cycom 5276-1 | 30 Pa-s | | |

With reference to FIG. 13, one approach for increasing resin viscosity is to lower the moulding temperature. In some examples, 8-ply 8HS specimens were used, applying a force of 4 kN and increasingly lower cure temperatures. For specimens tested at 100° C., for which the viscosity model predicts a moulding viscosity of approximately 20 Pa-s, significant amounts of shear flow were not observed, as illustrated in chart 1302.

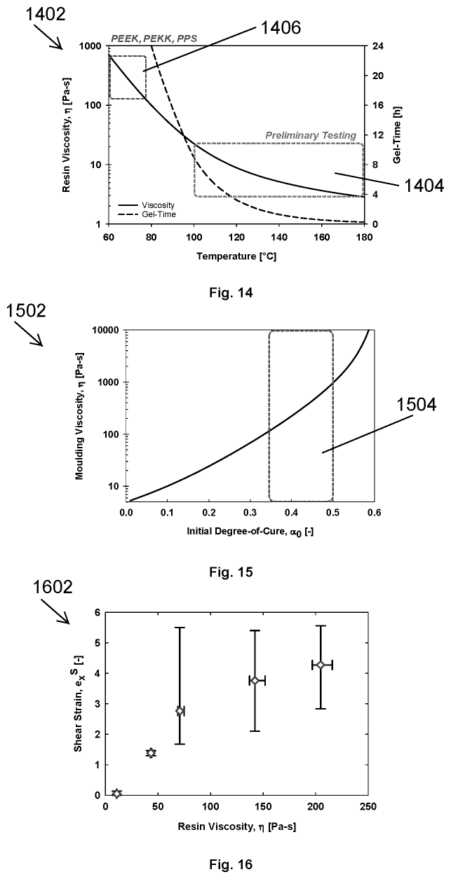

With reference to FIG. 14, the relationship between cure temperature, resin viscosity, and gel-time is illustrated in chart 1402. From this relationship, it was determined that lowering the moulding temperature to increase resin viscosity is limited by the exponential increase in gel-time corresponding to low cure temperatures. The highlighted regions 1404 and 1406 illustrate the gap between the viscosities covered during the preliminary low-temperature trials (at 1404) and the those of common compression moulding thermoplastics like PEEK, PEKK, and PPS (at 1406). Temperatures as low as 60-80° C. would be necessary to reach the viscosities larger than 100 Pa-s, at which point gelation would occur after more than 24 hours.

In another example, a two-step cure cycle in which flow occurs at low temperature and curing occurs during a secondary high temperature dwell was considered. However, this approach would extend cycle times and does not line up the industry standard of hot-in, hot-out compression moulding. In a further alternative example, with reference to FIG. 15, the processing viscosity of a thermoset can be elevated with an increase in the material's initial degree-of-cure. Chart 1502 shows the effect initial degree-of-cure has on the moulding viscosity of 5276-1 resin subjected to a cure temperature of 140° C. From this map, it seems feasible that a processing window similar to that of PEEK, PEKK, PPS, illustrated as region 1504, or any other of the compression moulding system from Table 10 could be obtained with 5276-1 and initial degree-of-cures of 0.35-0.5.

In one example, the relationship between resin viscosity and shear flow was assessed using flow-compaction specimens with a broad range of initial levels of cure, tested under identical moulding conditions. Offcuts of various as-received conditions were staged to generate the material needed for these tests. The staging procedure in this example is outlined herein:
1. A dynamic modulated DSC run was performed on each offcut batch to obtain initial glass transition temperature values. The DiBenedetto model for 5276-1 populated earlier then gave the corresponding degree-of-cure values.
2. The 5276-1 cure and viscosity models were used to determine staging times resulting in a range of processing viscosities from 10-1000 Pa-s.
3. Two 9.5 mm thick aluminium plates were preheated to a staging temperature of 120° C. inside of a standard convection oven.
4. 12.7 mm wide strips of 8HS/5276-1 prepreg, covered on each side with non-perforated release film, were placed in between the preheated plates and allowed to cure during a given staging time, depending on the desired degree-of-cure.
5. Prepreg strips were removed from the oven and immediately placed between another two aluminium plates at room-temperature to avoid further polymerization.
6. The staged degree-of-cure of each batch was verified by modulated DSC, as in step 1.
7. Each strip of staged prepreg is cut into 12.7 mm×12.7 mm strands for testing.

In this example, the reduction in resin modulus at elevated staging temperatures causes a relaxation of the prepreg fibre bed leading to a significant increase in strand thickness. In some cases, certain staging trials which were conducted did not involve cooling the prepreg strips under pressure, resulting very high bulk factors. It was noted that cooling under pressure allowed the resin to vitrify and maintain a smaller profile.

Continuing with this example, a test matrix used to evaluate the effect of resin viscosity on prepreg shear flow is presented in Table 11. A nominal mould closure rate was chosen based on the work of Rasheed (“Compression moulding of chopped woven thermoplastic composite flakes”, 2016, the entire contents of which are incorporated by reference herein) who studied the effect of closure rate on the squeeze flow behaviour of 5HS/PPS prepreg flakes. Rasheed observed that charges loaded at excessively slow rates (0.005 mm/s) could experience local fibre jamming resulting in resin starved regions and hindered overall material flow. Tests performed at rates higher than 0.05 mm/s showed no such behaviour, so 0.1 mm/s was determined to be a reasonable starting point for these trials. Each specimen was loaded to 1 kN of force.

TABLE 11
Staging configurations tested

| | | | Initial | | |
|---|---|---|---|---|---|
| | | | Degree- | | |
| Code | Conditions | Tg | of-Cure | Viscosity | Repetitions |
| S1 | 32 min | 7.15° C. | 0.11 | 11 Pa-s | 5 |
| | at 120° C. | | | | |
| S2 | 87 min | 26.2° C. | 0.24 | 43 Pa-s | 5 |
| | at 120° C. | | | | |
| S3 | 107 min | 32.4° C. | 0.29 | 71 Pa-s | 5 |
| | at 120° C. | | | | |
| S4 | 122 min | 41.3° C. | 0.35 | 142 Pa-s | 5 |
| | at 120° C. | | | | |
| S5 | 130.5 min | 45.8° C. | 0.38 | 205 Pa-s | 5 |
| | at 120° C. | | | | |

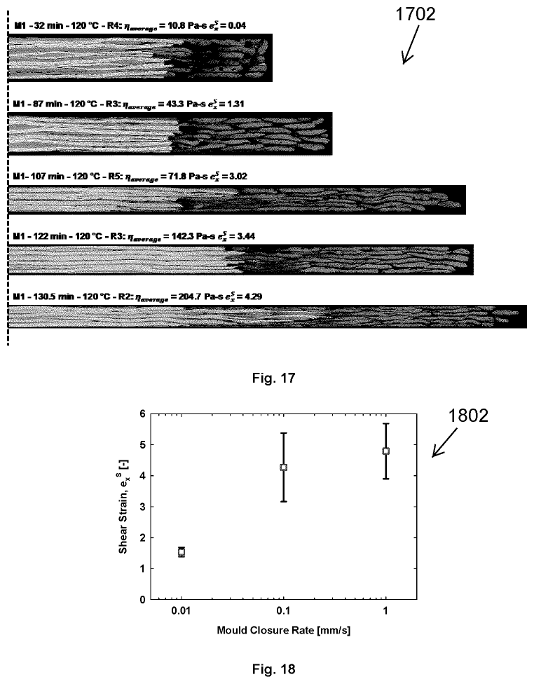

With reference to FIGS. 16 and 17, the shear strains obtained for all the staged specimens tested, along with their corresponding resin viscosities are illustrated in chart 1602. The error bars used represent the minimums and maximums, not the standard deviations. Specimen micrographs 1702 are representative of each condition's average value, to illustrate the changes in specimen morphology observed.

With continued reference to FIG. 17, it can be observed from micrographs 1702 that shear strain increases almost linearly with viscosity until it reaches approximately 3 at 70 Pa-s. At 70 Pa-s, at notable increase strain variability of roughly 0.1 to 5 is observed. This unstable behaviour gradually tapers off as viscosity and strain magnitude continue to increase suggesting a possible shift in flow mechanism dominance. Micrographs of specimens tested at 10 Pa-s and 40 Pa-s feature shear flow that is limited to 90° fibre bundles, which remain almost entirely intact. Movement of 0° fibres does not become apparent until above 70 Pa-s, where instability is first observed. It is after this point that the transition between 0° and 90° regions becomes less and less abrupt. For specimens tested at 200 Pa-s, this transition is at its most gradual and the resin rich zones that are visible in all previous cases have disappeared completely. Finally, a decrease in the quantity and size of voids present in the space between tows as viscosity increases. It is unclear what exactly causes this trend; however, it may be due to a more even pressure distribution within each specimen as the fibre volume content becomes less concentrated.

With additional reference to FIG. 18, chart 1802 illustrates the effect of mould closure rate on the shear strain of specimens staged to an initial degree-of-cure of 0.38 (viscosity of roughly 200 Pa-s).

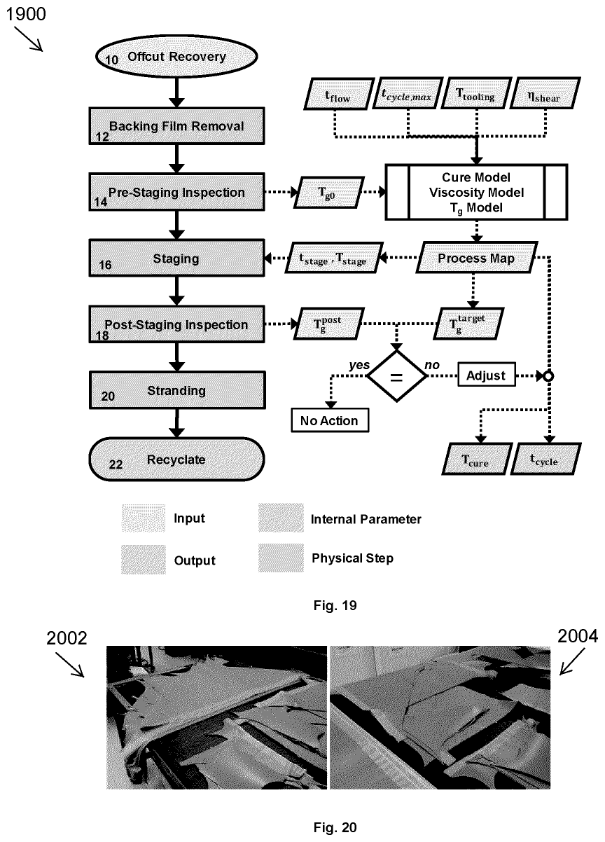

With reference to FIG. 19, having identified a range of viscosities in which large shear deformation of 8HS/5276-1 strands occurs, the present disclosure additionally provides a systematic framework to produce strands staged to the appropriate degree-of-cure given offcuts with unknown and highly variable thermal histories. The flow tailoring methodology illustrated at 1900 demonstrates one embodiment of the framework, which considers factors such as tooling material, cure temperature, and cycle time.

The flow tailoring method begins at step 10, with recovery of prepreg offcuts. The shape, size, quantity, and state will vary between batches. With additional reference to FIG. 20, example batches 2002 and 2004 of 8HS/5276-1 ply-cutter scrap. An input requirement or resin characterization is performed providing information related to the material being recycled and the end-user's needs. Target viscosity (ηₛₕₑₐᵣ) and flow window (t_{flow}) are material-specific parameters that are obtained through flow-compaction testing. In some embodiments, the target viscosity and flow window parameters are defined as ranges of any suitable size, for instance based on the conditions for the flow-compaction testing. Maximum cycle time (t_{cycle,max}) and tooling temperature (T_{tooling}) are chosen based on the user's needs.

At step 12, protective backing films are removed. At step 14, a pre-staging inspection of the offcuts is performed. This step can be performed manually or through some form of automation. In some embodiments, the pre-staging inspection is accomplished on DSC specimens prepared using coupons associated with particular batches of received offcuts. Each specimen is subjected to a dynamic temperature scan to determine the as-received glass transition temperature (T_{g0}). In some other embodiments, other types of thermochemical and/or thermomechanical inspections can be performed, including Fourier-transform infrared spectroscopy (FTIR), or the like.

At this point, a resin behaviour subroutine, for instance being part of a software application, generates process maps that allow the user to choose staging parameters (t_{stage}, T_{stage}, T_{g}^{target}) that satisfy their needs in terms of cure temperature (T_{cure}) and cycle time (t_{cycle}), while ensuring the recycled prepreg strands are processed at the appropriate viscosity (ηₛₕₑₐᵣ) as determined by a flow-compaction characterization. The subroutine was built using the phenomenological models for 5276-1 degree-of-cure, viscosity, and glass transition temperature.

At step 16, offcuts are staged, for instance in accordance with the staging procedure as outlined hereinabove.

At step 18, the offcuts are then processed to a post-staging inspection 18 which, similarly to the pre-staging inspection, a dynamic DSC temperature ramp is used to determine the material's glass transition temperature following the staging operation (T_{g}^{post}). This value is compared with the expected value from the process maps (T_{g}^{target}) and any inconsistency is accounted for with a modification to the cure temperature and cycle time.

At step 20, the staged prepreg is cut and slit in to strands. The size of the strands can be selected based on a variety of parameters. For instance, the strand sizing is determined based on the need for strength (bigger) or for better flow (smaller).

At step 22, the strands are compression moulded as described herein producing the recyclate.

In at least some embodiments, the method 1900 described herein provides for coupling of the resin behavior subroutine and flow-compaction method with a material database which results in recycling opportunities for a large number of material systems currently in-service.

In an embodiment it is provided that a batch of prepreg offcuts is received from a composite part manufacturer, material supplier, or third-party recycler. Offcuts can have, for example, a woven or non-woven fibre architecture. The reinforcement can be carbon, glass, or some other material. The matrix material can be epoxy based, vinyl-ester based, or otherwise.

If the appropriate resin behaviour models (e.g. cure, viscosity, modulus) do not already exist or are otherwise unavailable, then a resin characterization is performed and the appropriate models are populated.

If this is the first time recycling this particular type of offcut material, then flow-compaction testing is performed to determine the viscosity-rate-flow relationships previously discussed.

The batch of offcuts is inspected by DSC, or some other method if appropriate, to determine the as-received degree-of-cure.

Based on the as-received degree-of-cure, the results of the flow-compaction tests, and the users' moulding requirements, staging parameters are selected.

The batch of prepreg offcuts are staged based on the selected staging parameters. This step is carried out in an oven for example, or with any other device which can provide heat to the material in a controlled manner.

The staged offcuts are inspected by DSC, or some other method if appropriate, to determine the staged degree-of-cure.

If the staged degree-of-cure does not match the expected staged degree-of-cure, then the resin behaviour models are used to modify the moulding conditions to compensate for this discrepancy.

Staged prepreg offcuts are then cut and slit into strands. Strand size is selected based on the needs of the user. Larger strands are appropriate for low-flow high-strength applications. Smaller strands are appropriate for high-flow low-strength applications.

Finally, compression moulding of the desired component using the adjusted moulding conditions is carried out.

Accordingly, the process of recycling a prepreg material as described herein does not require new resin to be introduced. Prepreg staging as demonstrated herein improves the stability of the resin and removes tack for better handling. The process described herein allows for rapid curing and tailored flow without the need for a secondary resin system. Furthermore, the obtainable fiber volume fractions and resulting mechanical properties are not limiting factors, producing a higher quality recyclate.

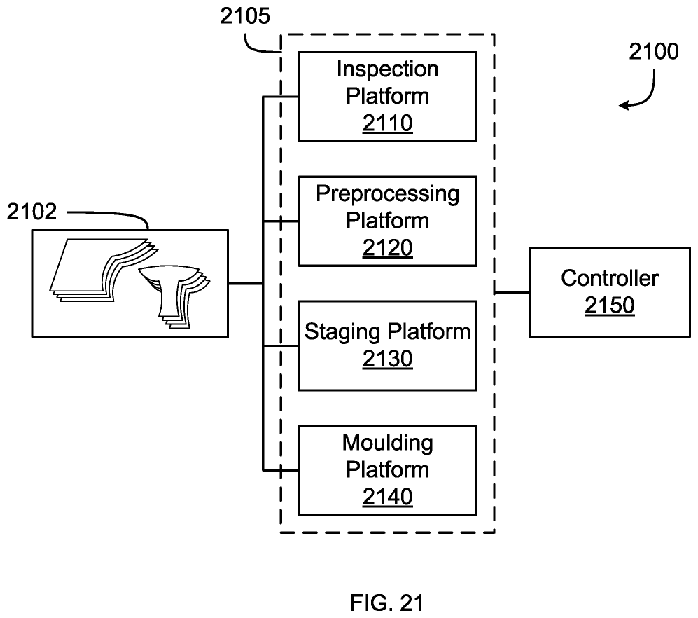

With reference to FIG. 21, a system 2100 for processing prepreg offcuts, for instance the offcuts 2102, is illustrated. The system 2100 includes an offcut processing platform 2105 and a controller 2150, which is communicatively coupled to the offcut processing platform 2105. The offcut processing platform 2105 is composed of an inspection platform 2110, a preprocessing platform 2120, a staging platform 2130, and a moulding platform 2140, which collaborate to process the prepreg offcuts 2102 as part of a recycling procedure whereby the prepreg offcuts are used for fabricating new components. The controller 2150 can be any suitable type of electronic control device, including microcontrollers, embedded computing devices, laptop or desktop computers, mobile devices, such as smartphones, or the like. The controller 2150 is configured for implementing instructions, provided via a software application or similar software element, for controlling the operation of one or more of the inspection platform 2110, a preprocessing platform 2120, a staging platform 2130, and a moulding platform 2140, and/or for providing guidance to an operator of one or more of the inspection platform 2110, a preprocessing platform 2120, a staging platform 2130, and a moulding platform 2140 regarding operation thereof. In some embodiments, the controller 2150 is a component of, or is embodied by, a larger computing system, which can include display devices for presentation of information to an operator.

The inspection platform 2110 includes various inspection tools for inspecting the prepreg offcuts 2102, components fabricated using the prepreg offcuts 2102, and intermediary products, including the strands formed from the prepreg offcuts 2102. In some embodiments, the inspection platform 2110 includes a differential scanning calorimetry device for performing dynamic and/or isothermal scans. For example, a glass transition temperature can be determined based on one or more experiments or inspections, which can be provided to the controller 2150 or to other elements of the offcut processing platform 2105, as appropriate, for use in other parts of the manufacturing process. In some other embodiments, the inspection platform can include additional inspection tools, including any one or more the aforementioned thermochemical and/or thermomechanical inspection tools. In some embodiments, the controller 2150 can control the inspection tools of the inspection platform 2110 to perform various inspection steps. In some other embodiments, the controller 2150 can provide to an operator of the inspection platform 2110, for instance via a screen or other presentation device, guidance on how to operate the inspection platform 2110. The guidance can include recommended settings for the inspection tools, recommendations on type of inspections to perform, a list or flowchart of steps to be implemented as part of an inspection protocol, or the like.

The preprocessing platform 2120 includes physical processing tools for effecting one or more preprocessing operations on the prepreg offcuts 2102. This can include tools and/or workspace for removing protective backings form the prepreg offcuts 2102, for cutting the prepreg offcuts 2102 into strands, and for performing any other physical manipulation of the prepreg offcuts 2102. In some embodiments, the controller 2150 is configured for automating one or more preprocessing operations, via automated tools. In some other embodiments, the controller 210 is configured for providing guidance to an operator of the preprocessing platform 2120, for instance via a screen or other presentation device, on how to operate the inspection platform 2110.

The staging platform 2130 includes staging tools for performing one or more staging operations on the prepreg offcuts 2102. The staging tools can include one or more ovens, one or more autoclaves, or similar tools, as appropriate. In some embodiments, the controller 2150 is configured for automating one or more staging operations, via automated control of the staging tools. For instance, the controller can be programmed to control the temperature and staging time for different groups of prepreg offcuts 2102. In some examples, the staging platform 2130 and the controller 2150 collaborate to establish a staging process for the prepreg offcuts 2102, as is discussed in greater detail hereinbelow. In some other embodiments, the controller 2105 is configured for providing guidance to an operator of the staging platform 2130, for instance via a screen or other presentation device, on how to operate the inspection platform 2110.

The moulding platform 2140 includes moulds and moulding tools for performing one or more moulding operations using the prepreg offcuts 2102, or byproducts thereof, for instance the aforementioned prepreg strands. The prepreg offcuts 2102 or strands can be disposed within the moulds by operators, or by automated tools, for instance as controlled by the controller 2105. In some embodiments, the controller 2105 is configured for providing guidance to the operator of the moulding platform. For instance, the controller 2105 can display a map or list of instructions detailing how the prepreg strands are to be disposed in the mould. In some embodiments, the controller 2105 can control a moulding process performed by the moulding platform, including controlling the temperature and moulding time for different moulding processes.

It should be noted that in some embodiments, the offcut processing platform 2105 can be provided with additional functionality. For example, the offcut processing platform 2105 can be provided with a design for a composite fabrication to be performed with non-offcuts. In this example, the offcut processing platform 2105 is configured for estimating the size, shape, and type of offcuts that will be produced as a result of the fabrication process. The offcut processing platform 2105 is also configured for suggesting modifications to the design, in order to minimize the amount of offcuts produced, or to maximize the amount of easily-recyclable offcuts that will be produced.

In some embodiments, the offcut processing platform 2105 can be embodied in a self-contained unit or device of any suitable shape and size. The device in which the offcut processing platform 2105 is embodied can be provided with the controller 2105, or can be provided with connectivity functionality to be able to connect to a remote instance of the controller 2105, which may be accessible over the Internet or another similar network.

It should additionally be noted that, in at least some embodiments, the present disclosure provides method and systems for recycling prepreg offcut material without the need of any additive or the use of any supplementary resin. It is nevertheless considered that in certain embodiments, certain additives may be used to assist the staging process and/or the curing process of composite components fabricated with recycled prepreg offcuts.

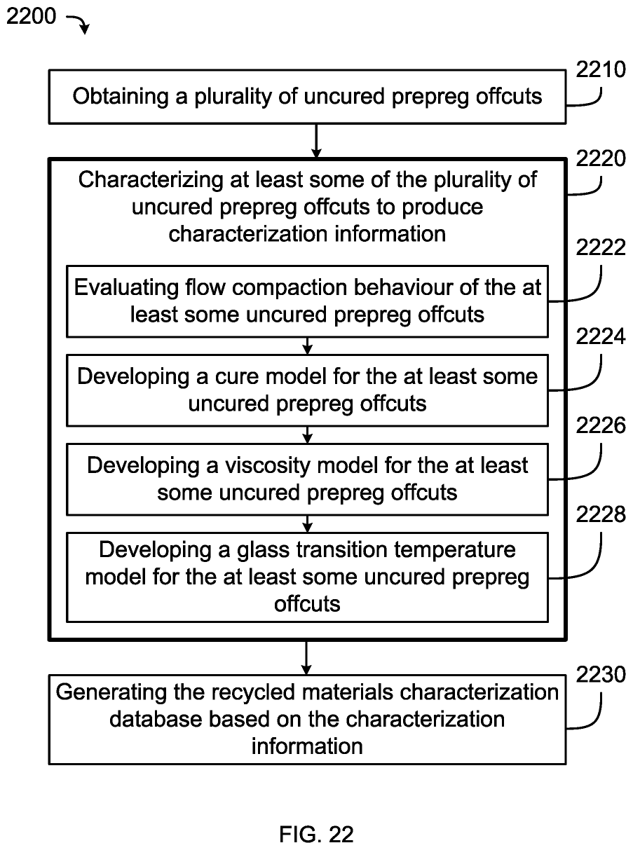

With reference to FIG. 22, there is illustrated a method 2200 for generating a recycled materials characterization database, for instance for use by the controller 2150 of the system 2100. The recycled materials characterization database can include information, algorithms, models, mathematical relationships, and/or similar elements for use by the controller 2150 in controlling the offcut processing platform 2105. At step 2210, a plurality of uncured prepreg offcuts are obtained, for instance the prepreg offcuts 2102. The offcuts can be of any suitable size and/or shape, and be of any suitable type of prepreg material.

At step 2220, at least some of the plurality of uncured prepreg offcuts 2102 are characterized to produce characterization information. As illustrated in FIG. 22, the step 2220 is composed of one or more steps. At step 2222, flow compaction behavior of the at least some uncured prepreg offcuts 2102 is evaluated. At step 2224, a cure model for the at least some uncured prepreg offcuts 2102 is developed. At step 2226, a viscosity model for the at least some uncured prepreg offcuts 2102 is developed. At step 2228, a glass transition temperature (T_{g}) model for the at least some uncured prepreg offcuts 2102 is developed. Development of the cure, viscosity, and T_{g} models, as well as the evaluation of the flow compaction behavior, can be performed in accordance with the present disclosure. The characterization information can include various mathematical relationships, statistical or numerical relationships, algorithms, and the like.

It should be noted that in some embodiments, one or more of the cure model, the viscosity model, and the T_{g} model may be omitted, or may be combined into one or more other models. For instance, information gathered from the flow compaction behavior testing performed at step 2222 can be used to generate one or more models which can be substituted for one or more of the cure, viscosity, and T_{g} models. Additionally, or in the alternative, one or more additional models can be developed, including modulus models, cure shrinkage models, thermal expansion models, and the like.

At step 2230, the recycled materials characterization database is generated based on the characterization information, obtained at step 2220. The generation of the recycled materials characterization database can include storing the characterization information in a particular data structure, including the elaboration of the data structure itself. The recycled materials characterization database can be located in any suitable data repository, and can be assessable via one or more local networks, or via one or more distributed networks, for instance the Internet.

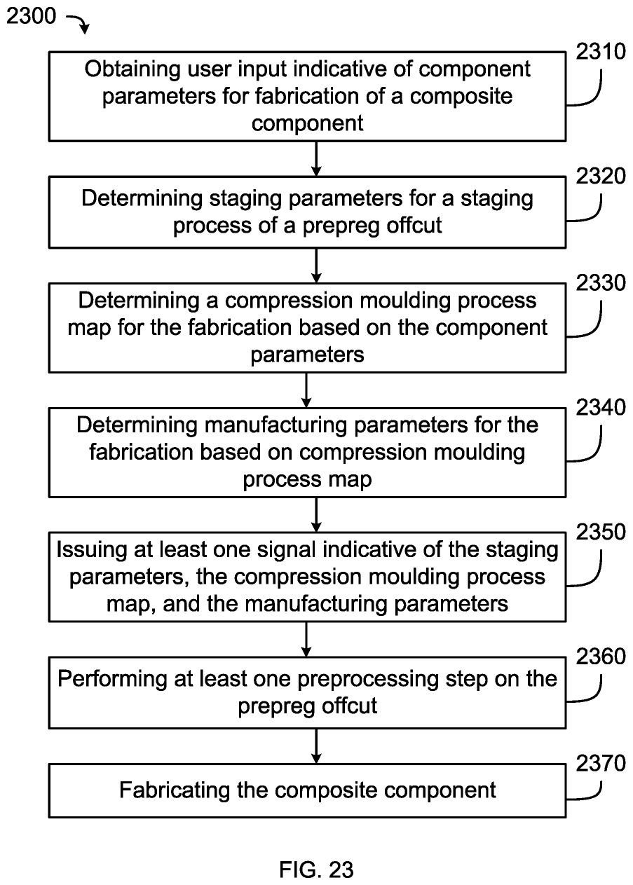

With reference to FIG. 23, the recycled materials characterization database generated via the method 2220 can be used as part of a process for manufacturing a composite component, as illustrated in the method 2300, using one or more prepreg offcuts. For simplicity, the foregoing disclosure refers to prepreg offcut in the singular, but it should be understood that the manufacturing process can use multiple prepreg offcuts, as appropriate. It should also be understood that in cases where multiple prepreg offcuts are used, the offcuts can be obtained from different sources, and that the offcuts could be of disparate material types, including different resin types and different fabric types.

At step 2310, a plurality of user inputs, indicative of component parameters for fabrication of the composite component, are obtained. The component parameters can include a complexity level for the composite component, a desired curing temperature for the composite component, a desired cure time for the composite component, and desired glass transition temperature for the composite component. For instance, a user may specify, via the user inputs, that a medium complexity component is desired to be cured for 45 min at 140° C., and that the component should have a T_{g} of 100° C. The user inputs can be provided to a computing system, for instance the controller 2105 of the system 2100, which can have stored therein, or be provided access to, the database generated via the method 2220.

At step 2310, user input indicative of component parameters for fabrication of a composite component is obtained. The component parameters can include one or more of a complexity level for the composite component, a desired cure temperature for the composite component, a desired cure time for the composite component, and a glass transition temperature for the composite component. The component parameters also include a prepreg offcut material parameter, which is indicative of a prepreg offcut to be recycled, for instance the prepreg offcuts 2102. For example, the prepreg offcut material parameter can be an indication of the type of prepreg offcut being used, the storage conditions for the prepreg offcut, or any other similar parameter.

In some embodiments, at least some of the component parameters are determined based on an inspection of the prepreg offcut. For example, an inspection process for the prepreg offcut can be performed to determine one or more of the component parameters. The inspection processes can be similar to those used performed by the inspection platform 2110.

At step 2320, staging parameters for a staging process of the prepreg offcut are determined. The staging parameters can be similar to those used by the staging platform 2130, and are determined based on the prepreg offcut material parameter. In some cases, the staging parameters are also determined based on other ones of the component parameters. In some embodiments, the staging parameters include at least one of a staging time, a staging temperature, and an staging glass transition temperature.

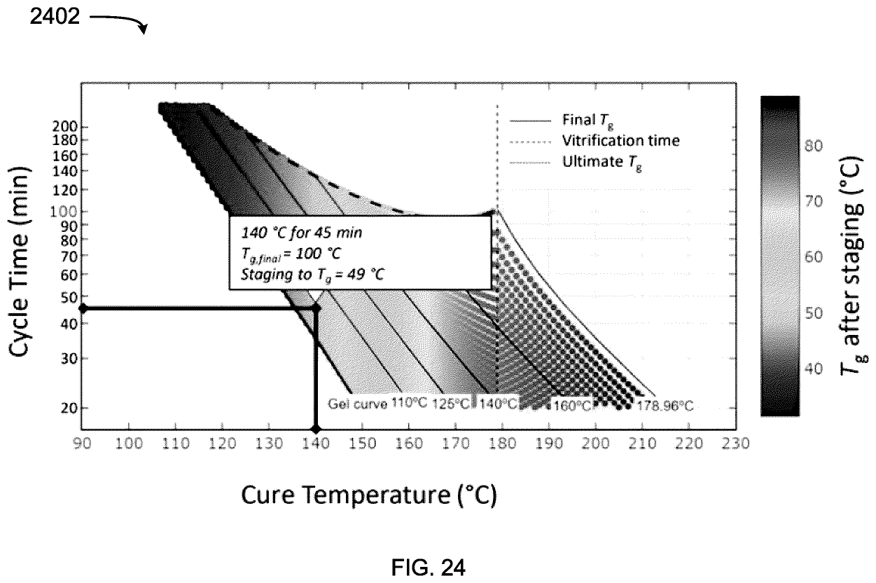

At step 2330, a compression moulding process map for the fabrication is determined based on the component parameters. With additional reference to FIG. 24, an example compression moulding process map is illustrated at 2402. The compression moulding process map can be determined using the recycled materials characterization database developed via the method 2200. In some embodiments, the compression moulding process map defines at least one of a cycle time, a cure temperature, and a staging glass transition temperature.

At step 2340, manufacturing parameters for the fabrication are determined based on the compression moulding process map. The manufacturing parameters can be similar to those used by the moulding platform 2140 and/or by the controller 2150. In some embodiments, the manufacturing parameters include at least one of a final glass transition temperature, a cure temperature, a manufacturing cure time, and a moulding viscosity.

At step 2350, one or more signals, indicative of the staging parameters, the compression moulding process map, and the manufacturing parameters, are issued. In some embodiments, one or more signals are issued for each of the staging parameters, the compression moulding process map, and the manufacturing parameters. In some other embodiments, one or more issued signals are indicative of multiple ones of the staging parameters, the compression moulding process map, and the manufacturing parameters. Alternatively, in some embodiments, the issued signals are indicative of a subset of the staging parameters, the compression moulding process map, and the manufacturing parameters, and other embodiments are also considered.

The signal(s) can be issued by the controller 2150, or by another suitable device, as appropriate. In some embodiments, the signal(s) are issued to one or more display devices, which can form part of the controller 2150 and/or the system 2100, to display information, instructions, or other guidance to an operator of the offcut processing platform 2105. In some other embodiments, the signal(s) are control signals issued to one or more components within the offcut processing platform 2105 to effect control of automated tools or processes, as appropriate. Other embodiments are also considered.

At step 2360, one or more preprocessing steps are performed on the prepreg offcut. The preprocessing steps can be similar to those performed by the preprocessing platform 2120. The preprocessing steps can be performed by an automated tool, for instance based on the signal(s) issued at step 2350, or by an operator based on guidance provided via the signal(s). At step 2370, the composite component is fabricated based on the signal(s), in either an automated fashion, or based on guidance provided by the information in the signal(s).

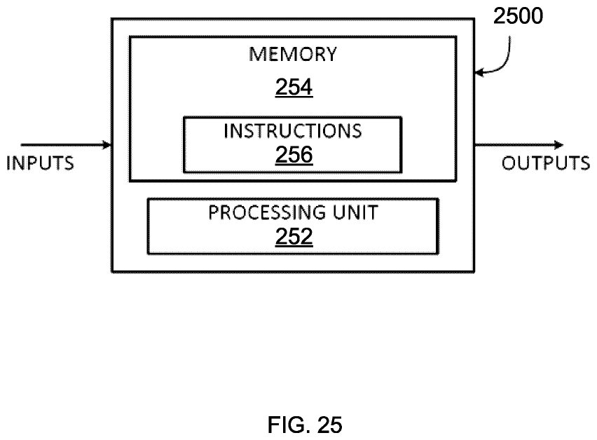

With reference to FIG. 25, the controller 2105 may be implemented by a computing device 2500, comprising a processing unit 252 and a memory 254 which has stored therein computer-executable instructions 256. The processing unit 252 may comprise any suitable devices configured to cause a series of steps to be performed so as to implement the methods 1900, 2200, and/or 2300 such that instructions 256, when executed by the computing device 2500 or other programmable apparatus, may cause the functions/acts/steps specified in the methods described herein to be executed. The processing unit 252 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 254 may comprise any suitable known or other machine-readable storage medium. The memory 254 may comprise non-transitory computer readable storage medium such as, for example, but not limited to, an electronic, magnetic, optical, electromagnetic, infrared, or semiconductor system, apparatus, or device, or any suitable combination of the foregoing. The memory 254 may include a suitable combination of any type of computer memory that is located either internally or externally to device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory may comprise any storage means (e.g., devices) suitable for retrievably storing machine-readable instructions executable by processing unit.

The methods and systems described herein may be implemented in a high level procedural or object oriented programming or scripting language, or a combination thereof, to communicate with or assist in the operation of a computer system, for example the computing device 2500. Alternatively, the methods and systems described herein may be implemented in assembly or machine language. The language may be a compiled or interpreted language. Program code for implementing the methods and systems for monitoring a temperature of a gas turbine engine may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 252 of the computing device 2500, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

While the present disclosure has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

1. A method for manufacturing a composite component, comprising:
obtaining user input indicative of component parameters for fabrication of the composite component, the component parameters including a prepreg offcut material parameter indicative of a prepreg offcut to be recycled;
determining at least one staging parameter for a staging process of the prepreg offcut based on the prepreg offcut material parameter;
determining a compression moulding process map for the fabrication based on the component parameters;
determining manufacturing parameters for the fabrication based on the compression moulding process map; and
issuing at least one signal indicative of the staging parameters, the compression moulding process map, and the manufacturing parameters.

2. The method of claim 1, wherein the component parameters include at least one of a complexity level for the composite component, a desired cure temperature for the composite component, a desired cure time for the composite component, and a glass transition temperature for the composite component.

3. The method of claim 1, wherein the staging parameters include at least one of a staging time, a staging temperature, and an staging glass transition temperature.

4. The method of claim 1, wherein the compression moulding process map defines at least one of a cycle time, a cure temperature, and a staging glass transition temperature.

5. The method of claim 1, wherein the manufacturing parameters include at least one of a final glass transition temperature, a cure temperature, a manufacturing cure time, and a moulding viscosity.

6. The method of claim 1, comprising inspecting the prepreg offcut, wherein the component parameters include at least one parameter determined based on the inspecting.

7. The method of claim 1, comprising performing at least one preprocessing step on the prepreg offcut, the at least one preprocessing step comprising at least one of removal of a backing film from the prepreg offcut and cutting the prepreg offcut into a plurality of strands.

8. The method of claim 1, comprising fabricating the composite component based on the at least one issued signal.

9. The method of claim 1, wherein issuing the at least one signal comprises issuing at least one command to an automated prepreg offcut recycling device.

10. The method of claim 1, wherein issuing the at least one signal comprises causing at least one of the staging parameters, the compression moulding process map, and the manufacturing parameters to be displayed to an operator via at least one display device.

11. A system for manufacturing a composite component, comprising:
a processor; and
a non-transitory computer-readable medium having stored thereon program instructions executable by the processor for:
obtaining user input indicative of component parameters for fabrication of the composite component, the component parameters including a prepreg offcut material parameter indicative of a prepreg offcut to be recycled;
determining at least one staging parameter fora staging process of the prepreg offcut based on the prepreg offcut material parameter;
determining a compression moulding process map for the fabrication based on the component parameters;
determining manufacturing parameters for the fabrication based on the compression moulding process map; and
issuing at least one signal indicative of the staging parameters, the compression moulding process map, and the manufacturing parameters.

12. (canceled)

13. (canceled)

14. (canceled)

15. (canceled)

16. (canceled)

17. (canceled)

18. (canceled)

19. (canceled)

20. (canceled)

21. A process of recycling a prepreg material comprising a resin producing a moulding composition comprising:
recovering prepreg offcuts;
flow-compaction testing of the offcuts to determine staging parameters in view desired cure temperature (T_{cure}) and cycle time (t_{cycle});
staging the offcuts;
determining the staged offcuts glass transition temperature (T_{g}^{post}) and comparing the glass transition temperature to the expected glass transition temperature (T_{g}^{target}) and accounting differences with a modification to the cure temperature and cycle time;
stranding the staged cuts into strands; and
compression moulding the strands producing the moulding composition.

22. The process of claim 21, further comprising characterizing the resin from the offcuts after recovering the prepeg offcuts.

23. The process of claim 21, wherein the resin is extracted with a razor blade before being characterized.

24. The process of claim 21, wherein the target viscosity (ηₛₕₑₐᵣ) and flow window are further determined during the flow-compaction testing.

25. The process of claim 21, comprising selecting cycle time (t_{cycle,max}) and tooling temperature (T_{cooling}) after the flow-compaction testing.

26. The process of claim 21, further comprising removing a protective backing film from the prepreg offcuts before the recycling process.

27. The process of claim 26, wherein the protective backing film is removed manually or through automation.

28. The process of claim 21, wherein the flow-compaction testing is accomplished on coupons collected from the offcuts.

29. The process of claim 28, wherein the coupons are subjected to a dynamic temperature scan to determine a glass transition temperature as received (T_{g0}).

30. The process of claim 21, further generating a process map allowing choosing the staging parameters (t_{stage}, T_{stage}, T_{g}^{target}) in terms of desired cure temperature (T_{cure}), cycle time (t_{cycle}), and resin viscosity.

31. The process of claim 21, wherein the strands are stored in sealed bags at −18° C. or at room temperature before being moulded.
